(19) United States
(12) Patent Application Publication
(10) Pub. No.: US 2023/0307967 A1
(43) Pub. Date: Sep. 28, 2023

(54) STATOR AND ELECTRIC MOTOR

(71) Applicant: FANUC CORPORATION, Yamanashi (JP)

(72) Inventor: Tetsumaru SAITOU, Yamanashi-ken (JP)

(21) Appl. No.: 18/023,096

(22) PCT Filed: Aug. 25, 2021
(86) PCT No.: PCT/JP2021/031078

§ 371 Date: Feb. 24, 2023

(30) Foreign Application Priority Data
Aug. 31, 2020 (JP) 2020-145609

(51) Int. Cl. H02K 1/18

(52) U.S. Cl. CPC H02K 1/185

(57) ABSTRACT

Provided are a stator and an electric motor that are configured such that the stator can be arranged properly with respect to a housing. The stator of one embodiment includes: a stator core; a coil provided on the stator core and having a coil portion protruding in a direction of an axis (AX) from each of both end surfaces of the stator core in the direction of the axis: and a coating resin coating the coil portion. At least one of the both end surfaces of the stator core in the direction of the axis is partially exposed from the coating resin.

### TECHNICAL FIELD

The present invention relates to a stator and an electric motor.

### BACKGROUND ART

JP 2014-110716 A discloses a stator including a stator core, a coil, and a cover. The coil is provided on the stator core. The cover surrounds a coil portion (coil end). The coil portion protrudes from an axial end surface of the stator core.

### SUMMARY OF THE INVENTION

Incidentally, the cost of the cover disclosed in JP 2014-110716 A tends to increase. Accordingly, there is a demand to omit the cover. However, if the cover of the stator disclosed in JP 2014-110716 A is omitted, when the stator is inserted into an insertion hole formed in the housing of the electric motor, it is difficult to position the stator in the housing.

Therefore, an object of the present invention is to provide a stator and an electric motor in which the stator can be appropriately disposed with respect to a housing.

According to one aspect of the present invention, there is provided a stator including: a stator core; a coil provided on the stator core and including coil portions protruding, in a direction of an axis of the stator core, respectively from both end surfaces of the stator core in the direction of the axis; and coating resins with which the coil portions are coated respectively, wherein a portion of at least one end surface of the both end surfaces of the stator core in the direction of the axis is exposed from the coating resin.

According to another aspect of the present invention, there is provided an electric motor including: a stator; and a rotor fixed to a housing including an insertion hole into which the stator is inserted, wherein the stator includes: a stator core; a coil provided on the stator core and including coil portions protruding, in a direction of an axis of the stator core, respectively from both end surfaces of the stator core in the direction of the axis; and coating resins with which the coil portions are coated respectively, wherein a portion of at least one end surface of the both end surfaces of the stator core in the direction of the axis is exposed from the coating resin, the housing is provided with a projection protruding toward the insertion hole, and a position of the stator, in the direction of the axis, relative to the housing is fixed by the projection coming into contact with the one end surface of the stator core exposed from the coating resin.

With the above aspects of the present invention, the end surfaces of the stator core exposed from the coating resin can serve as a stopper when the stator is inserted into the insertion hole of the housing. As a result, the stator can be appropriately disposed relative to the housing.

### BRIEF DESCRIPTION OF DRAWINGS

FIG. 1 is a perspective view showing a stator of an embodiment;

FIG. 2 is a cross sectional view taken along line II-II of FIG. 1;

FIG. 3 is a cross sectional view taken along line III-III of FIG. 2;

FIG. 4 is a view showing how the stator is attached to a housing of an electric motor;

FIG. 5 is a view showing a stator according to a first modification, from the same viewpoint as FIG. 2; and

FIG. 6 is a cross sectional view taken along line VI-VI of FIG. 5.

### DETAILED DESCRIPTION OF THE INVENTION

A preferred embodiment of the present invention will be detailed below with reference to the accompanying drawings.

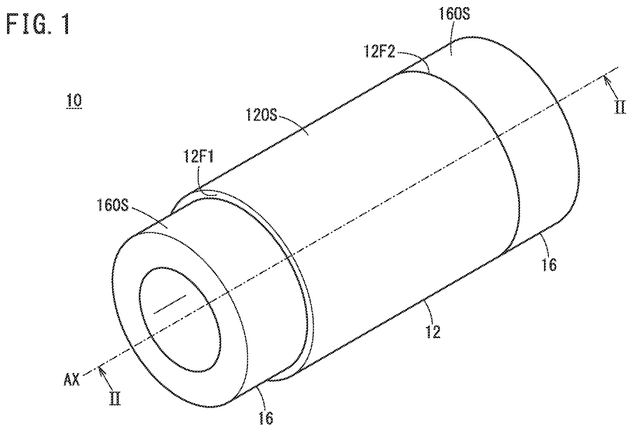

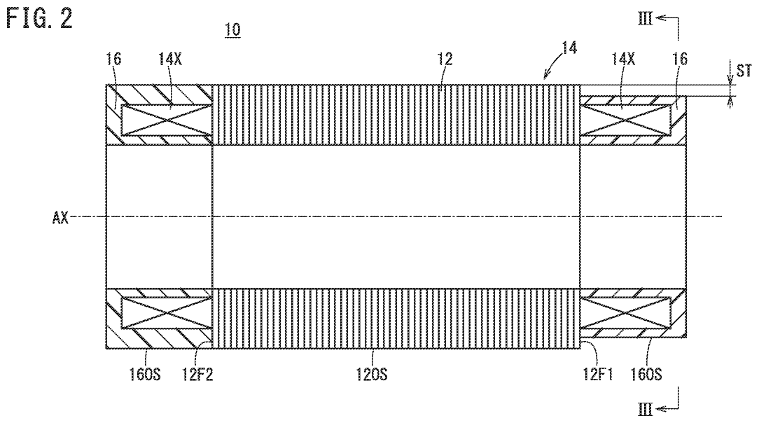

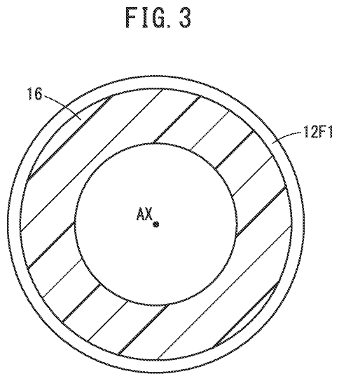

A stator 10 according to the embodiment will be described with reference to FIGS. 1 to 3. FIG. 1 is a perspective view showing the stator 10 of the embodiment. FIG. 2 is a cross sectional view taken along line II-II of FIG. 1. FIG. 3 is a cross sectional view taken along line III-III of FIG. 2. The stator 10 includes a stator core 12, a coil 14, and a coating resin 16.

The stator core 12 is formed in a tubular shape. Both the end surfaces of the stator core 12 in the direction of an axial AX (an axial direction), i.e., one end surface 12F1 and the other end surface 12F2 of the stator core, extend along the radial direction of the stator core 12.

A portion of the end surface 12F1 is exposed from the coating resin 16. The exposed portion of the end surface 12F1 exposed from the coating resin 16 is a portion that lies between the outer circumferential surface 120S of the stator core 12 and the outer circumferential surface 160S of the coating resin 16. On the other hand, the end surface 12F2 is entirely covered with the coating resin 16.

The coil 14 is provided on the stator core 12. The coil 14 includes a coil portion 14X. The coil portion 14X protrudes outward along the axial direction of the stator core 12 from each of both the end surfaces 12F1 and 12F2 in the axial direction of the stator core 12. The coil portion 14X is generally called a coil end.

The coating resin 16 is a resin with which the coil portion 14X is coated. The coating resin 16 is cured (hardened). The coating resin 16 is formed by, for example, molding. The cross sectional shape of the coating resin 16 along the radial direction of the stator core 12 is the same as the cross sectional shape of the stator core 12 along the radial direction. In FIGS. 1 to 3, a case where the cross sectional shape of the stator core 12 in the radial direction is circular is illustrated.

The outer diameter of the coating resin 16 in contact with the end surface 12F1 is smaller than the outer diameter of the stator core 12. That is, the coating resin 16 in contact with the end surface 12F1 is provided on the inner side relative to the outer circumferential surface 120S of the stator core 12. In addition, a stepped space ST (FIG. 2) is formed between the outer circumferential surface 160S of the coating resin 16 in contact with the end surface 12F1 and the outer circumferential surface 120S of the stator core 12.

The outer diameter of the coating resin 16 in contact with the end surface 12F2 is the same as the outer diameter of the stator core 12. The outer diameter of the coating resin 16 in contact with the end surface 12F2 may be different from the outer diameter of the stator core 12 within an allowable error range.

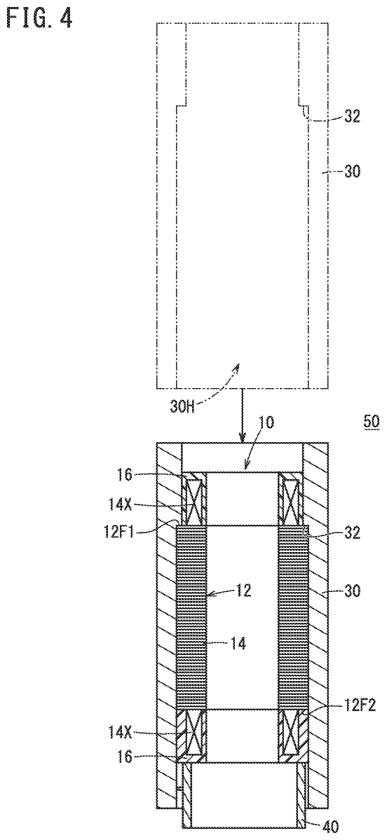

Next, an electric motor 50 including the above-described stator 10 will be described. FIG. 4 is a view showing how the stator 10 is attached to a housing 30 of the electric motor 50.

The electric motor 50 includes the stator 10 and a rotor (not shown) fixed to the housing 30. The housing 30 includes an insertion hole 30H into which the stator 10 is inserted. The housing 30 includes a projection 32 projecting toward the insertion hole 30H. When the stator 10 is inserted into the insertion hole 30H, the projection 32 comes into contact with the exposed portion of the end surface 12F1 of the stator core 12 exposed from the coating resin 16.

The electric motor 50 is manufactured by inserting the above-described stator 10 into the insertion hole 30H of the housing 30 and attaching the inserted stator 10 to the housing 30.

For inserting the stator 10 into the insertion hole 30H of the housing 30, first, the stator 10 is placed on a fixture 40. In the example of FIG. 4, the coating resin 16 in contact with the end surface 12F2 of the stator core 12 is placed on the placement surface of the fixture 40. Next, the stator 10 placed on the fixture 40 is inserted into the insertion hole 30H of the housing 30 from the end surface 12F1 of the stator core 12.

At the time of this insertion, the projection 32 of the housing 30 passes through the stepped space ST (FIG. 2) which lies between the outer circumferential surface 160S of the coating resin 16 in contact with the end surface 12F1 and the outer circumferential surface 120S of the stator core 12. Thereafter, the projection 32 of the housing 30 comes into contact with the exposed portion of the end surface 12F1 of the stator core 12 exposed from the coating resin 16. As a result, in the electric motor 50, the axial position of the stator 10 with respect to the housing 30 is fixed.

As described above, in the stator 10 of the present embodiment, the end surface 12F1 of the stator core 12 exposed from the coating resin 16 can be used as a stopper when the stator 10 is inserted into the insertion hole 30H of the housing 30. Therefore, the stator 10 can be appropriately disposed with respect to the housing 30.

In a state where the stator 10 is attached to the housing 30, the coating resin 16 in contact with the end surface 12F1 of the stator core 12 and the coating resin 16 in contact with the end surface 12F2 are in contact with the housing 30. As a result, heat dissipation can be enhanced compared to the case where the coating resin 16 is not in contact with the housing 30.

### [Modifications]

The above embodiment may be modified as follows.

### (Modification 1)

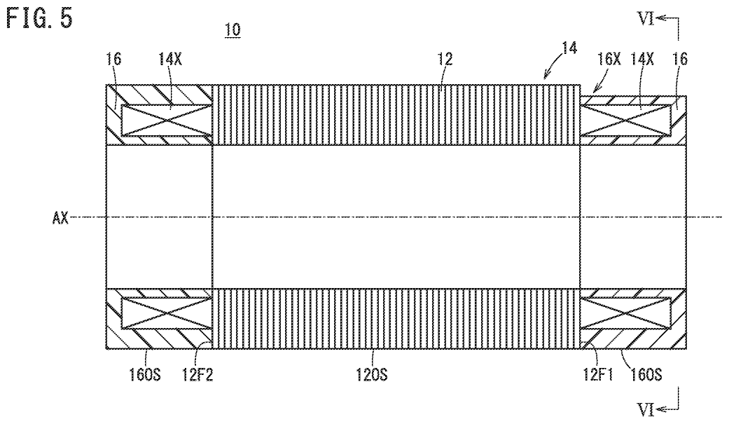

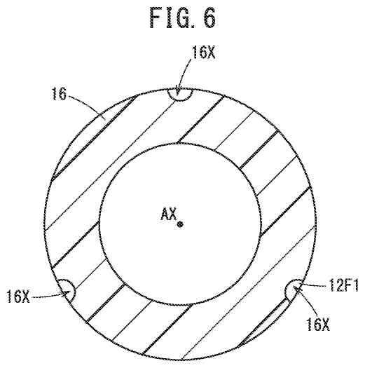

FIG. 5 is a view showing the stator 10 according to a first modification from the same viewpoint as FIG. 2. FIG. 6 is a cross sectional view taken along line VI-VI of FIG. 5.

In the present modification, a cutout 16X is provided in the outer circumferential surface 160S of the coating resin 16 that is in contact with the end surface 12F1 of the stator core 12. The cutout 16X extends from a distal end of the coating resin 16 in the direction of the axis AX to the end surface 12F1 of the stator core 12.

As illustrated in FIG. 6, the number of the cutouts 16X may be plural. In addition, the number of the cutouts 16X may be one. When the number of the cutouts 16X is plural, the cutouts 16X are arranged at intervals in the circumferential direction about the axis AX of the stator core 12.

The outer diameter of the coating resin 16 in contact with the end surface 12F1 of the stator core 12 is approximately the same as the outer diameter of the stator core 12. That is, in the present modification, the exposed portion of the end surface 12F1 exposed from the coating resin 16 is a portion of the cutout 16X.

The stator 10 of the present modification is inserted into the insertion hole 30H of the housing 30 from the end surface 12F1 of the stator core 12, similarly to the above-described embodiment. A projection corresponding to the cutout 16X is formed in the housing 30 of the present modification. When the stator 10 is inserted into the insertion hole 30H, the projection passes through the cutout 16X and comes into contact with the exposed portion of the end surface 12F1 of the stator core 12, which is exposed from the coating resin 16. Thus, the axial position of the stator 10 with respect to the housing 30 is fixed. Therefore, similarly to the above-described embodiment, the end surface 12F1 can be used as a stopper when the stator 10 is inserted into the insertion hole 30H of the housing 30. As a result, even in the present modification, the stator 10 can be appropriately disposed with respect to the housing 30.

Further, in the case of the present modification, the housing 30 can be guided by the cutout 16X such that the angle of the housing with respect to the stator core 12 in the circumferential direction about the axis AX is in a predetermined state.

### (Modification 2)

In the present modification, in a state where the stator 10 is attached to the housing 30, the coating resin 16 in contact with the end surface 12F1 comes into contact with the housing 30 when the temperature of the electric motor 50 reaches a specified temperature. When the temperature of the electric motor 50 does not reach the specified temperature, the coating resin 16 in contact with the end surface 12F1 is not in contact with the housing 30. The method for achieving the above includes the following method as a specific example.

Here, the outer diameter of the coating resin 16 is defined as “D0”, the outer diameter of the stator core 12 is defined as “D1”, the coefficient of linear thermal expansion of the coating resin 16 is defined as “k0”, and the coefficient of linear thermal expansion of the stator core 12 is defined as “k1”. The temperature of the electric motor 50 is defined as “t”, and the room temperature is defined as “tr”. In this case, the outer diameter D0t of the coating resin 16 at the specified temperature is expressed by the following equation (1), and the outer diameter D1t of the stator core 12 at the specified temperature is expressed by the following equation (2).

D0t=DO0+D0×(t−tr)×k0 (1)

D1t=D1+D1×(t−tr)×k1 (2)

When the outer diameter D0t of the coating resin 16 at the specified temperature is equal to the outer diameter D1t of the stator core 12 at the specified temperature, the above equations (1) and (2) are equal to each other. Therefore, the following equation (3) is derived from the above equations (1) and (2).

D0=D1(1+k1(t−tr))/(1+k0(t−tr)) (3)

Based on the above equation (3), when the temperature of the electric motor 50 reaches the specified temperature, the coating resin 16 in contact with the end surface 12F1 can be brought into contact with the housing 30. Examples of the specified temperature include a temperature that the temperature of the electric motor 50 reaches in accordance with heat generated during rated operation.

As described above, according to the second modification, when the temperature of the electric motor 50 is lower than the specified temperature, the ventilation characteristic can be increased. In addition, when the temperature of the electric motor 50 is equal to or higher than the specified temperature, the heat dissipation can be enhanced.

### (Modification 3)

The end surface 12F2 of the stator core 12 may be provided with an exposed portion that is exposed from the coating resin 16. With this configuration, regardless of whether the axial end surface 12F1 or the axial end surface 12F2 of the stator core 12 is inserted into the insertion hole 30H of the housing 30, the stator 10 can be appropriately disposed with respect to the housing 30.

In the above-described embodiment, only the end surface 12F1 of the both end surfaces 12F1 and 12F2 of the stator core 12 is provided with the exposed portion that is exposed from the coating resin 16. In the case of the above-described embodiment, the operator can visually grasp which of both end surfaces 12F1 and 12F2 of the stator 10 should be inserted into the insertion hole 30H of the housing 30, based on the presence or absence of the exposed portion.

### [Inventions]

First and second aspects of the present invention are described below as inventions that can be grasped from the above embodiment and modifications.

### (First Invention)

A first aspect of the present invention is characterized by the stator (10) including: the stator core (12); the coil (14) provided on the stator core (12) and including the coil portions (14X) protruding, in the direction of the axis (AX) of the stator core (12), respectively from the both end surfaces (12F1, 12F2) of the stator core (12) in the direction of the axis (AX); and the coating resins (16) with which the coil portions (14X) are coated respectively. In the stator (10), a portion of at least one end surface of the both end surfaces (12F1, 12F2) of the stator core (12) in the direction of the axis (AX) is exposed from the coating resin (16).

With this configuration, the end surface (12F1) exposed from the coating resin (16) can serve as a stopper when the stator (10) is inserted into the insertion hole (30H) of the housing (30). As a result, the stator (10) can be appropriately disposed relative to the housing (30).

The portion of the one end surface of the both end surfaces (12F1, 12F2) of the stator core (12) in the direction of the axis (AX) may be exposed from the coating resin (16), and another end surface of the both end surfaces (12F1, 12F2) of the stator core (12) in the direction of the axis (AX) may be entirely covered with the coating resin (16). This allows the operator to visually recognize which of the axial end surfaces of the stator (10) should be inserted into the insertion hole (30H) of the housing (30), depending on the presence or absence of the exposed portion.

The cross sectional shape of the coating resin (16) along the radial direction of the stator core (12) may be the same as the cross sectional shape of the stator core (12) along the radial direction. Thus, the coating resin (16) and the stator core (12) can be brought into contact with each other.

At least one coating resin (16) of the coating resins with which the coil portions (14X) are coated respectively may be provided on the inner side relative to the outer circumferential surface (12OS) of the stator core (12), and the portion of the one end surface (12F1) of the stator core (12) exposed from the coating resin (16) may be a region between the outer circumferential surface (12OS) of the stator core (12) and the outer circumferential surface (16OS) of the coating resin (16). With this configuration, the region between the outer circumferential surface (12OS) of the stator core (12) and the outer circumferential surface (16OS) of the coating resin (16) can serve as a stopper when the stator (10) is inserted into the insertion hole (30H) of the housing (30).

At least one cutout (16X) may be provided on the outer circumferential surface (16OS) of at least one coating resin (16) of the coating resins with which the coil portions (14X) are coated respectively, the at least one cutout extending from the distal end of the one coating resin (16) in the direction of the axis (AX) to the one end surface (12F1) of the stator core (12) that has the portion exposed from the coating resin, and the portion of the one end surface (12F1) of the stator core (12) exposed from the coating resin (16) may be a region where the cutout (16X) is located. Thus, the region where the cutout (16X) is located can be used as a stopper when the stator (10) is inserted into the insertion hole (30H) of the housing (30). Further, the housing (30) can be guided by the cutout (16X) so that the angle of the stator core (12) relative to the housing in the circumferential direction about the axis (AX) is in a predetermined state.

### (Second Invention)

A second aspect of the present invention is characterized by the electric motor (50) including: the stator (10); and the rotor fixed to the housing (30) including the insertion hole (30H) into which the stator (10) is inserted, wherein the stator includes: the stator core (12); the coil (14) provided on the stator core (12) and including the coil portions (14X) protruding, in the direction of the axis (AX) of the stator core (12), respectively from both the end surfaces (12F1, 12F2) of the stator core (12) in the direction of the axis (AX); and the coating resins (16) with which the coil portions (14X) are coated respectively. In the electric motor (50), a portion of at least one end surface of the both end surfaces (12F1, 12F2) of the stator core (12) in the direction of the axis (AX) is exposed from the coating resin (16), the housing (30) is provided with the projection (32) protruding toward the insertion hole (30H), and a position of the stator (10), in the direction of the axis (AX), relative to the housing (30) is fixed by the projection (32) coming into contact with the one end surface (12F1) of the stator core (12) exposed from the coating resin (16).

With this configuration, the end surface (12F1) exposed from the coating resin (16) can serve as a stopper when the stator (10) is inserted into the insertion hole (30H) of the housing (30). As a result, the stator (10) can be appropriately disposed relative to the housing (30).

The portion of the one end surface of the both end surfaces (12F1, 12F2) of the stator core (12) in the direction of the axis (AX) may be exposed from the coating resin (16), and another end surface of the both end surfaces (12F1, 12F2) of the stator core (12) in the direction of the axis (AX) may be entirely covered with the coating resin (16). This allows the operator to visually recognize which of the axial end surfaces of the stator (10) should be inserted into the insertion hole (30H) of the housing (30), depending on the presence or absence of the exposed portion.

The cross sectional shape of the stator core (12) in the direction orthogonal to the direction of the axis (AX) may be the same as the cross sectional shape of the coating resins (16). Thus, the coating resin (16) and the stator core (12) can be brought into contact with each other.

At least one coating resin (16) of the coating resins with which the coil portions (14X) are respectively coated may be provided on the inner side relative to an outer circumferential surface (12OS) of the stator core (12), and the portion of the one end surface (12F1) of the stator core (12) exposed from the coating resin (16) may be a region between the outer circumferential surface (12OS) of the stator core (12) and an outer circumferential surface (16OS) of the coating resin (16). With this configuration, the region between the outer circumferential surface (12OS) of the stator core (12) and the outer circumferential surface (16OS) of the coating resin (16) can serve as a stopper when the stator (10) is inserted into the insertion hole (30H) of the housing (30).

At least one cutout (16X) may be provided on the outer circumferential surface (16OS) of at least one coating resin (16) of the coating resins with which the coil portions (14X) are coated respectively, the at least one cutout extending from the distal end of the one coating resin (16) in the direction of the axis (AX) to the one end surface (12F1) of the stator core (12) that has the portion exposed from the coating resin, and the portion of the one end surface (12F1) of the stator core (12) exposed from the coating resin (16) may be a region where the cutout (16X) is located. Thus, the region where the cutout (16X) is located can be used as a stopper when the stator (10) is inserted into the insertion hole (30H) of the housing (30). Further, the housing (30) can be guided by the cutout (16X) so that the angle of the stator core (12) relative to the housing in the circumferential direction about the axis (AX) is in a predetermined state.

1. A stator comprising:
a stator core;
a coil provided on the stator core and including coil portions protruding, in a direction of an axis of the stator core, respectively from both end surfaces of the stator core in the direction of the axis; and
coating resins that coat the coil portions respectively,
wherein
a portion of at least one end surface of the both end surfaces of the stator core in the direction of the axis is exposed from the coating resin.

2. The stator according to claim 1, wherein
the portion of the one end surface of the both end surfaces of the stator core in the direction of the axis is exposed from the coating resin, and another end surface of the both end surfaces of the stator core in the direction of the axis is entirely covered with the coating resin.

3. The stator according to claim 1, wherein
cross sectional shapes of the coating resins along a radial direction of the stator core are a same as a cross sectional shape of the stator core along the radial direction.

4. The stator according to claim 1, wherein
at least one coating resin of the coating resins that coat the coil portions respectively is provided on an inner side relative to an outer circumferential surface of the stator core, and
the portion of the one end surface of the stator core exposed from the coating resin is a region between the outer circumferential surface of the stator core and an outer circumferential surface of the coating resin.

5. The stator according to claim 1, wherein
at least one cutout is provided on an outer circumferential surface of at least one coating resin of the coating resins that coat the coil portions respectively, the at least one cutout extending from a distal end of the one coating resin in the direction of the axis to the one end surface of the stator core that has the portion exposed from the coating resin, and
the portion of the one end surface of the stator core exposed from the coating resin is a region where the cutout is located.

6. An electric motor comprising: a stator; and a rotor fixed to a housing including an insertion hole into which the stator is inserted, wherein the stator includes: a stator core; a coil provided on the stator core and including coil portions protruding, in a direction of an axis of the stator core, respectively from both end surfaces of the stator core in the direction of the axis; and coating resins that coat the coil portions respectively,
wherein
a portion of at least one end surface of the both end surfaces of the stator core in the direction of the axis is exposed from the coating resin,
the housing is provided with a projection protruding toward the insertion hole, and
a position of the stator relative to the housing in the direction of the axis is fixed by the projection coming into contact with the one end surface of the stator core exposed from the coating resin.

7. The electric motor according to claim 6, wherein
the portion of the one end surface of the both end surfaces of the stator core in the direction of the axis is exposed from the coating resin, and another end surface of the both end surfaces of the stator core in the direction of the axis is entirely covered with the coating resin.

8. The electric motor according to claim 6, wherein
in a direction orthogonal to the direction of the axis, a cross sectional shape of the stator core is a same as cross sectional shapes of the coating resins.

9. The electric motor according to claim 6, wherein
at least one coating resin of the coating resins that coat the coil portions respectively is provided on an inner side relative to an outer circumferential surface of the stator core, and
the portion of the one end surface of the stator core exposed from the coating resin is a region between the outer circumferential surface of the stator core and an outer circumferential surface of the coating resin.

10. The electric motor according to claim 6, wherein
at least one cutout is provided on an outer circumferential surface of at least one coating resin of the coating resins that coat the coil portions respectively, the at least one cutout extending from a distal end of the one coating resin in the direction of the axis to the one end surface of the stator core that has the portion exposed from the coating resin, and
the portion of the one end surface of the stator core exposed from the coating resin is a region where the cutout is located.
